(19) United States
(12) Patent Application Publication
(10) Pub. No.: US 2011/0311694 A1
(43) Pub. Date: Dec. 22, 2011

(54) DEVICE FOR PRODUCING MILK FROTH

(75) Inventors: Markus Broennimann, Nidau (CH); Christoph Lehner, Elfingen (CH)

(73) Assignee: DELICA AG, Birsfelden (CH)

(21) Appl. No.: 13/254,130

(22) PCT Filed: Mar. 3, 2010
(86) PCT No.: PCT/EP2010/052649

§ 371 Date: Aug. 31, 2011

(30) Foreign Application Priority Data
Mar. 3, 2009 (EP) 09154238.1

(51) Int. Cl. A47J 31/44; A23C 9/00; B01F 3/04

(52) U.S. Cl. 426/474; 99/453

(57) ABSTRACT

The invention relates to a device for producing milk froth using steam and air, comprising a convergent-divergent nozzle for achieving a suction effect. A milk feed line is connected to the nozzle in such a way that milk can be drawn from a milk container into a nozzle under the suction effect. The nozzle is designed as a one-piece component created in an injection-molding process and contains a nozzle inlet opening, a nozzle outlet opening, and a milk feed line connection in the form of a milk intake fitting. The air inlet is located before a nozzle inlet opening of the nozzle with regard to the flow direction. A controllable air pump is provided to introduce air into the steam feed line.

The invention relates to a device for producing milk froth as claimed in the preamble of claim 1. A device of this kind can be used to produce milk froth for coffee beverages such as cappuccino or latte macchiato. The device can be part of an arrangement comprising a coffee machine. However, it goes without saying that it is also feasible to design the device as a stand-alone machine.

Systems for producing milk froth have been used for a relatively long time. A device which is comparable to the generic type is disclosed in WO 2005/102126 A2. Said document describes a coffee machine to which a mobile unit having a milk container and Venturi-type nozzle for frothing milk can be docked. The nozzle has a nozzle inlet opening for the steam, an air inlet, a milk inlet and also a nozzle outlet opening. An angled pipe piece which creates the discharge opening is fixed to the nozzle outlet opening. The air which is required to generate the milk froth is available as ambient air and is drawn into the nozzle using the suction effect. One disadvantage of this device is, for example, that it is relatively complicated to actuate and regulate the air supply. As a result, the milk froth and therefore the quality of the coffee/milk beverage often fail to meet relatively high requirements. For example, it has been found in practice that it is relatively difficult to control the temperature of the milk froth which is produced using this device. In particular, the device has a relatively complicated design. This relates, in particular, to the milk frother nozzle which is of multi-part design. Therefore, the nozzle would not be suitable as a disposable article.

EP 1 707 090 discloses a device for generating milk froth which is provided with a mixing element. The mixing element has at least one steam inlet duct which can be connected to a steam supply line, a milk inlet duct which can be connected to a milk supply line, a dispensing duct which can be connected to a dispensing line, and also an air inlet duct. However, a nozzle for producing a suction action for the milk is not provided. The milk is necessarily supplied by means of a pump.

Finally, DE 44 45 436 discloses a frothing device for frothing milk. In addition to a nozzle part, said frothing device has a feed line for steam, a feed line for air and a feed line for milk, with the feed lines being merged in a mixing region. The feed line for the air is connected to a compressed air source for blowing in air in a controllable manner. The location in which air is blown into the steam line can be upstream of the nozzle part in this case. However, said device is compact and not operator-friendly. Irrespective of this, cleaning of the nozzle part is problematical.

The object of the invention is therefore to avoid the disadvantages of the known documents and, in particular, to provide a device of the type cited in the introductory part with which the air supply for generating milk froth can be varied in a simple manner. In particular, the device is intended to allow the air supply to be actuated and regulated in an advantageous manner. The device is also intended to be distinguished by a simple design and improved hygiene and it is intended to be user-friendly.

According to the invention, these objects are achieved by a device which exhibits the features of claim 1. The device for producing milk froth and also possibly for heating milk can have a steam supply line to which the nozzle which is provided with a nozzle inlet opening can be connected in the direction of flow. The nozzle can have a nozzle duct, the cross section of said nozzle duct tapering from the nozzle inlet opening into a constricted duct section. The duct cross section can then widen in the direction of a nozzle outlet opening. The milk can be drawn into the nozzle from the milk container using the suction action which is generated by the accelerated flow in the constricted duct section. Numerous advantages are created by the air inlet not being located in the nozzle but rather outside the nozzle. For example, the nozzle itself can be of simple design. However, the local displacement of the air inlet also has advantages in respect of control and regulation. Furthermore, the arrangement according to the invention also has a favorable effect on hygiene since only a few parts or sections of the device come into contact with milk.

The device has an air pump which is or can be connected to the air inlet opening by means of an air feed line means in order to introduce air into the steam supply line. The air feed line means can be an air supply line. A line of this kind can be designed as a hose. However, valves are also feasible air feed line means. The air supply can be set and controlled in a particularly simple manner by virtue of connecting an air pump to the steam supply line in this way. It goes without saying that the device can also be operated in such a way that milk can be heated (without generating milk froth). The air pump can be, for example, a diaphragm or compressor air pump.

Dividing the device into a stationary appliance component and into a mobile nozzle component has the advantageous effect that virtually all the controllable elements which are required for forming froth can be accommodated in an appliance housing and, as a result, handling of the milk container and/or the nozzle is not adversely affected. Since, for example in contrast to WO 2005/102126 as cited in the introductory part, the air supply does not have to be controlled at the nozzle component, the nozzle itself can be of extremely simple design and, if required, can even be designed as a disposable article. Incorrect manipulations which can lead to insufficient froth formation are reliably precluded.

In connection with the claimed device, the terms “stationary” and “mobile” mean that the nozzle component can be detached from the appliance component, for example for cleaning purposes, and can be re-inserted, while the appliance component can always be in the same location. However, it goes without saying that the appliance component can also be mobile in the sense of it being possible to easily change the location of said appliance component at any time. However, built-in versions are also feasible, for example in combined kitchen appliances. In the present case, the term “milk supply line” is to be understood as any fixed or flexible line, irrespective of its length, which opens into the nozzle.

It can be particularly advantageous when the device has control means by means of which the air pump for prespecifying the mixing ratio of the steam/air mixture in the steam supply line can be actuated. The control means can contain microprocessors. The air supply can therefore be easily varied, as a result of which different milk beverages and coffee/milk beverages, such as cappuccino and latte macchiato, can be prepared in a simple manner and to a high quality. However, the air pump can also be actuated by means of the control means in such a way that the air pump is not activated or the air pump runs only in a partial-load mode for the “hot milk” mode. The temperature of the steam/air stream can be set in a simple and advantageous manner using this arrangement. Furthermore, air supply by means of the described actuated air pump ensures that a sufficient quantity of hot milk froth or hot milk can be produced.

The device can also have a water container, a water pump which is connected to said water container, and a steam generator which is connected to said water pump and by means of which steam can be fed to the steam supply line. It can be particularly advantageous when the device has control means for varying the pumping capacity of the water pump.

The nozzle can have a milk supply duct which preferably opens into the nozzle duct approximately in the region of the narrowest point in the constricted duct section. Milk can be drawn by suction into the nozzle in a particularly efficient manner by this arrangement by virtue of utilizing the suction effect.

In a further embodiment, it can be advantageous when the nozzle is in the form of a preferably integral component which is preferably produced using an injection-molding process and which is advantageously composed of plastic. A nozzle of this kind can be produced in a simple and cost-effective manner. The nozzle would therefore be a suitable disposable article. This integral component can have the nozzle inlet opening, the nozzle outlet opening and a milk supply line connection. In this case, the milk supply line connection can be designed as a milk intake fitting for connection of the milk supply line, which milk intake fitting surrounds a milk supply duct which is connected to the nozzle duct. The milk supply line is or can be detachably fixed to the milk intake fitting by means of a plug-type or snap-action connection.

The nozzle outlet opening of the nozzle can have an exposed discharge opening for discharging the milk froth into a cup. Therefore, additional components for creating a discharge opening are not required.

The nozzle duct can have a deflection, so that the direction of flow in the region of the nozzle inlet opening and the direction of flow in the region of the nozzle outlet opening run at any desired angle, but preferably at a right angle, to one another. It may then be advantageous when the milk supply duct opens into the nozzle duct approximately at a right angle in the region of the deflection or downstream of the deflection. The duct sections which are associated with the nozzle inlet opening and the nozzle outlet opening in each case and the milk supply duct can each therefore be oriented at a defined angle, preferably at a right angle. However, it goes without saying that it would also be feasible for the nozzle duct to run in a straight line, so that the main direction of flow between the nozzle inlet opening and in the region of the nozzle outlet opening remains unchanged.

Handling can be further simplified when the nozzle is or can be connected to the steam supply line by means of a bayonet fitting. However, it goes without saying that the nozzle could also be detachably connected to the steam supply line in some other way. For example, quick-action couplings or a threaded coupling with the aid of a union nut or simply just plug-type couplings without a locking means would be feasible.

The nozzle is or can be pivotably, preferably detachably, fixed to a cover part of the milk container. In a starting position, the nozzle can be fixed to the milk container in a space-saving manner. The nozzle can be pivoted out into a discharge position to such a degree that the milk froth can be discharged directly into a cup.

Air is particularly advantageously supplied to the steam supply line by means of a diaphragm, preferably with a diameter (diaphragm aperture) of between 0.2 mm and 2 mm. This diaphragm can also be in the form of a slit diaphragm or have any other desired geometric shape.

A further aspect of the invention relates to an arrangement comprising the above-described device and a coffee machine for brewing coffee. Coffee machines of this kind can be, for example, fully automatic coffee machines in which coffee beans are first automatically ground, and then brewed, after a button is pressed. It goes without saying that the coffee machine can also be a machine which operates using capsules, pouches or other portion packs.

The appliance component can comprise a housing having a docking point for accommodating the milk container, said docking point being in the form of, for example, an accommodation recess. In addition, the entire appliance component can be docked to a coffee machine with at least water and electricity being supplied by means of the coffee machine.

The steam generator can be actuated in such a way that residual water and/or steam, which remain in said steam generator depending on preceding or subsequent process steps, can be expelled by heating the steam generator. This ensures that the system is changed over to a defined state with an empty steam generator before the actual steam generation process begins. The expulsion process is preferably performed before each froth generation process when the steam generator has fallen below a certain temperature. As a result, the water which has flowed into the steam generator on account of a negative pressure or water from a rinsing or descaling process is reliably expelled.

During the heating process, a defined quantity of water is pumped back into the system in order to be able to build up a first steam cushion before the actual delivery of froth. In this case, excess steam can be let out via an overpressure valve which limits the excess steam pressure which is building up. As an alternative, it would be possible to reduce excess steam pressure through a controlled steam valve in the steam supply line. This could be, for example, a manifold valve.

The steam supply line and nozzle can be flushed with water, for cleaning purposes, in such a way that no milk is drawn by suction via the milk supply line and no water can enter the milk container. To this end, the quantity of water and the flow rate of the water pump have to be correspondingly adjusted by the manufacturer. A rinsing operation of this kind has the advantage that the milk container does not have to be removed for the rinsing process.

The mobile nozzle component can be particularly advantageously rotatably or pivotably mounted on the appliance component, it being possible to connect a milk container to the milk supply line independently of the nozzle component. This has the advantage that the nozzle component does not have to be removed together with the milk container, and therefore, for example, the milk container does not unnecessarily take up space in the refrigerator.

However, as an alternative, the nozzle can be, preferably detachably, fixed in a cover part of the milk container. The milk container is then associated with the mobile nozzle component for all intents and purposes. In this case, it is particularly advantageous when the nozzle is mounted rotatably in the cover part in such a way that the nozzle is connected to the appliance component in a first rotation position and is separated from the appliance component in a second rotation position. This can be achieved in a particularly advantageous manner with the aid of a bayonet fitting.

It may also be advantageous when the connection of the nozzle component to the appliance component can be established with the aid of a sensor, it being possible to activate steam generation in the appliance component only when the nozzle component is connected. This prevents hot steam being able to escape from the appliance component in an uncontrolled manner when the nozzle component is not inserted. The sensor is advantageously associated with the appliance component and is operatively connected to the control system in the appliance component. Said sensor can be a mechanical sensor, for example a microswitch, or an electrical sensor.

Particularly good results can be achieved when the air can be fed to the steam supply line at a pressure of between 0.2 and 2 bar, preferably at approximately 1 bar. Commercially available air pumps which do not take up too much space can be used in this pressure range.

The nozzle can have a diameter of between 0.5 and 2.5 mm, preferably of approximately 1.5 mm, in the region of its narrowest point. It is also expedient when the milk supply line upstream of the nozzle has a cross section of between 0.5 and 2.5 mm², preferably of approximately 1.25 mm². The diameter at the inlet into the nozzle duct which adjoins the region of the narrowest point can be between 0.6 mm and 2.7 mm, preferably approximately 1.7 mm. These dimensions could also be highly advantageous for nozzles of conventional devices for forming milk froth.

It is also expedient when the nozzle has an outflow diameter of between 2 and 15 mm, preferably of approximately 6 mm to 8 mm. This ensures good froth distribution irrespective of the size of the cup.

It is further expedient when a 3/2-way shut-off valve is arranged between the steam generator and the nozzle, said 3/2-way shut-off valve ventilating the steam supply line in the downstream direction in the closed state. This reliably prevents milk being drawn by suction into the steam generator. As an alternative, a so-called vacuum relief valve in the form of a non-return valve could be incorporated in order to prevent the vacuum. A vacuum could also be prevented by maintaining the operation of the air pump or by designing the air inlet opening in an appropriate manner.

In terms of energy, the steam heater is preferably designed in such a way that it is possible to generate froth within 60 seconds, preferably within at least 30 seconds, given an appropriate pump output for the water pump and given appropriate design of the line cross section with a completely cold system.

In addition, it may be advantageous for specific types of appliance when the milk supply line and the nozzle outlet opening of the nozzle, or a discharge pipe which is connected to said nozzle outlet opening, are arranged on the mobile nozzle component in such a way that milk can be drawn by suction from a milk container, in particular from a cup, and can be dispensed back into the same milk container again as hot milk or milk froth. This clearly requires a geometric arrangement of the corresponding components, so that this circulation operation is possible even in the case of relatively small vessels. However, it would also be feasible for the intake pipe and/or dispensing pipe to be of at least partially flexible design. The use of the device in circulation operation has the major advantage that only that quantity of milk which is required at that particular moment is used, without it being necessary to store milk in the device, this being critical in the uncooled state.

Further individual features and advantages of the invention can be gathered from the following description of an exemplary embodiment and from the drawings, in which:

FIG. 1 shows an arrangement having a coffee machine and a device for producing milk froth,

FIG. 2 is a highly simplified schematic illustration of a device according to the invention for producing milk froth,

FIG. 3 is a perspective exploded illustration of the device for producing milk froth for the arrangement according to FIG. 1,

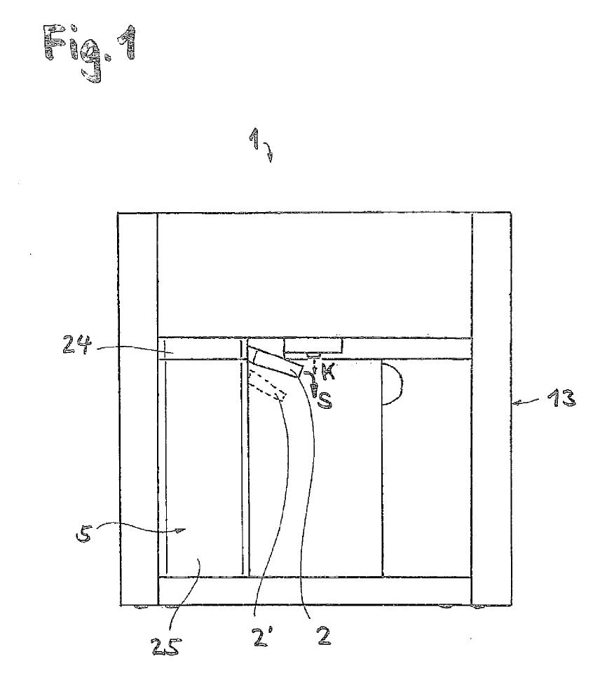

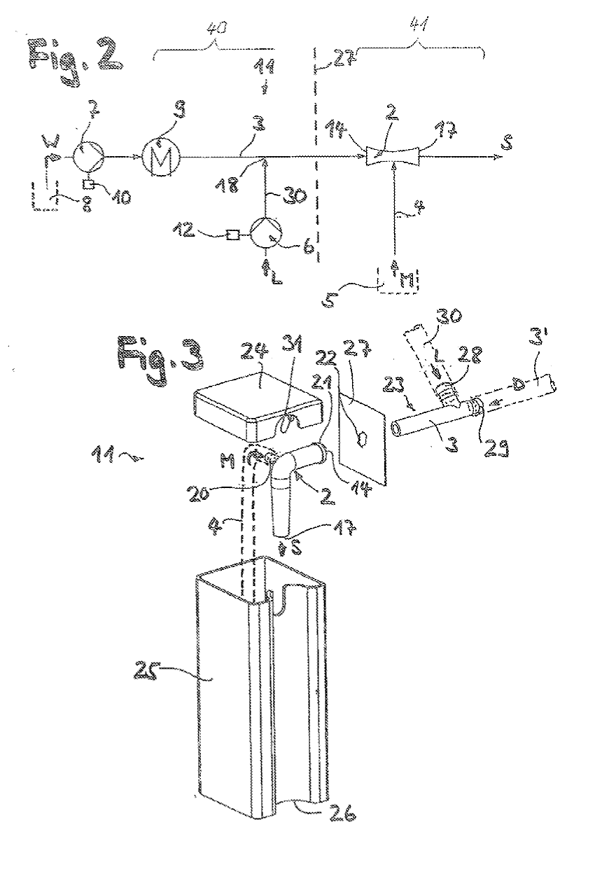

FIG. 4 shows a side view of the device according to FIG. 3,

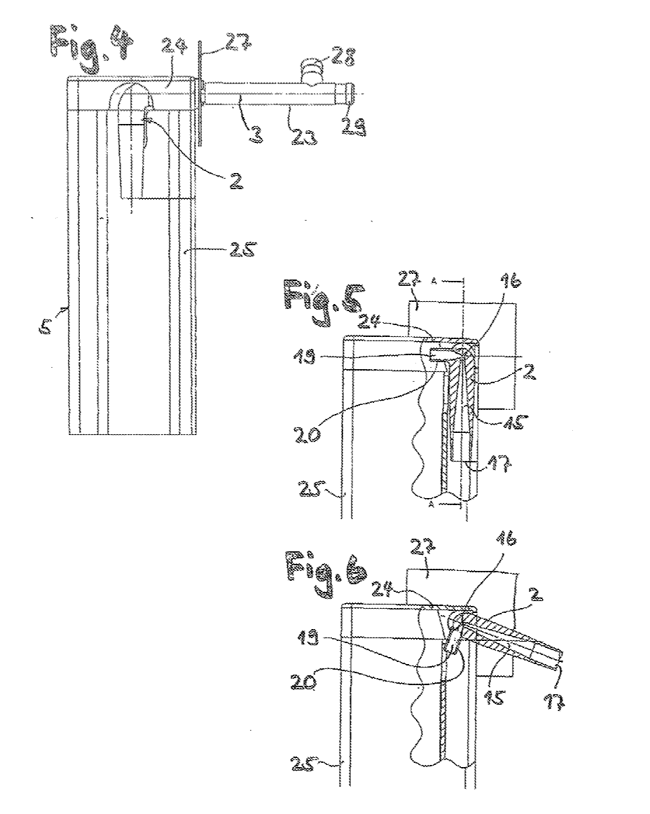

FIG. 5 shows a further side view with a partial section through the device with a nozzle in a starting position,

FIG. 6 shows the device with a nozzle pivoted out,

FIG. 7 is a sectional illustration of the device along section line A-A according to FIG. 5,

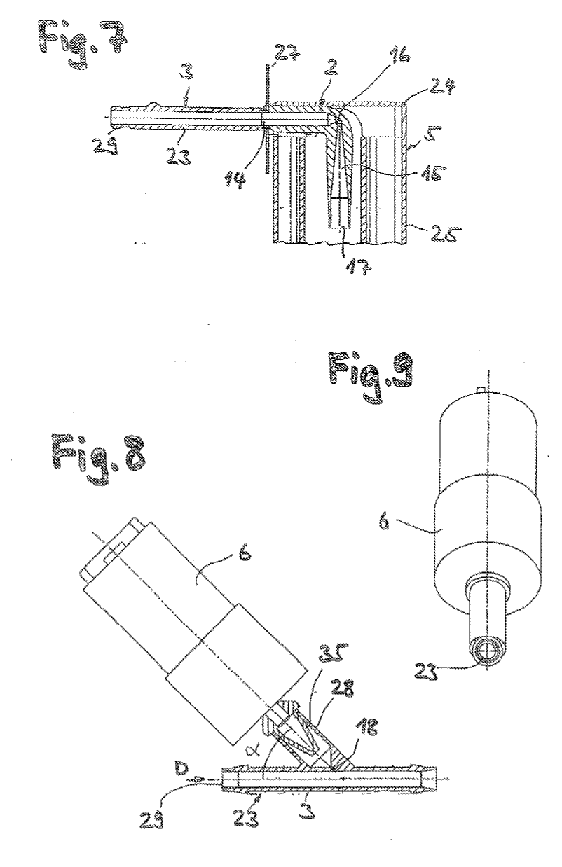

FIG. 8 shows a longitudinal section through a pipe piece of the steam supply line and an air pump which is connected to said pipe piece,

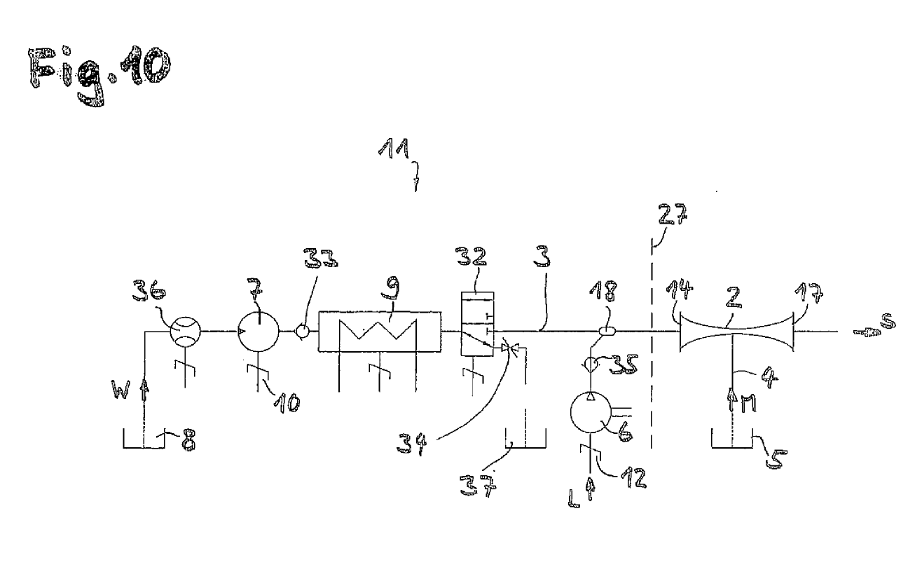

FIG. 9 shows a perspective front view of the pipe piece with the air pump according to FIG. 8,

FIG. 10 is a schematic illustration of a further device for producing milk froth,

FIG. 11 is a perspective illustration of a further arrangement which can be docked to a coffee machine,

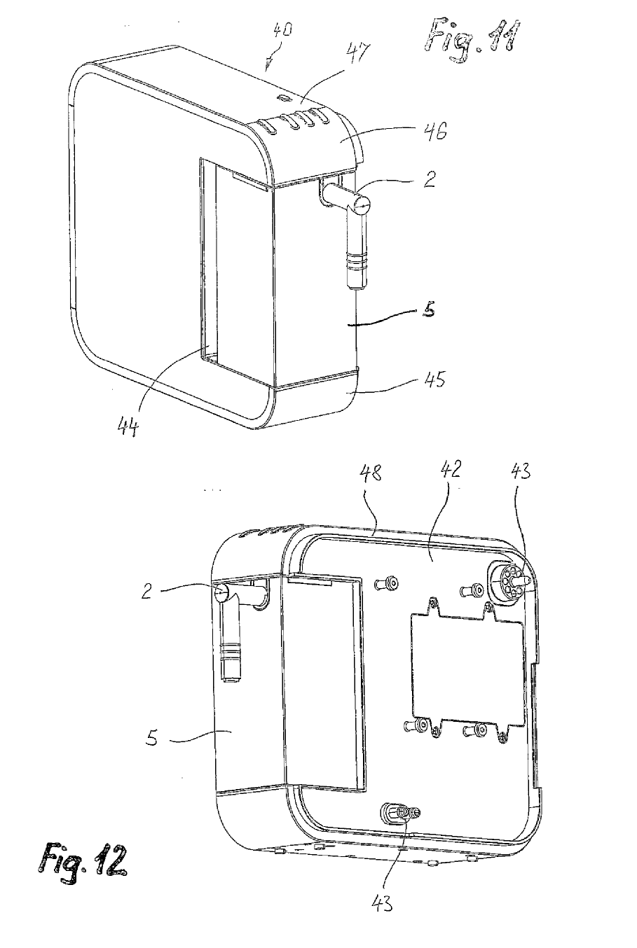

FIG. 12 shows the arrangement according to FIG. 11 from a different perspective,

FIG. 13 shows a side view of the arrangement according to FIG. 11 with the side wall removed,

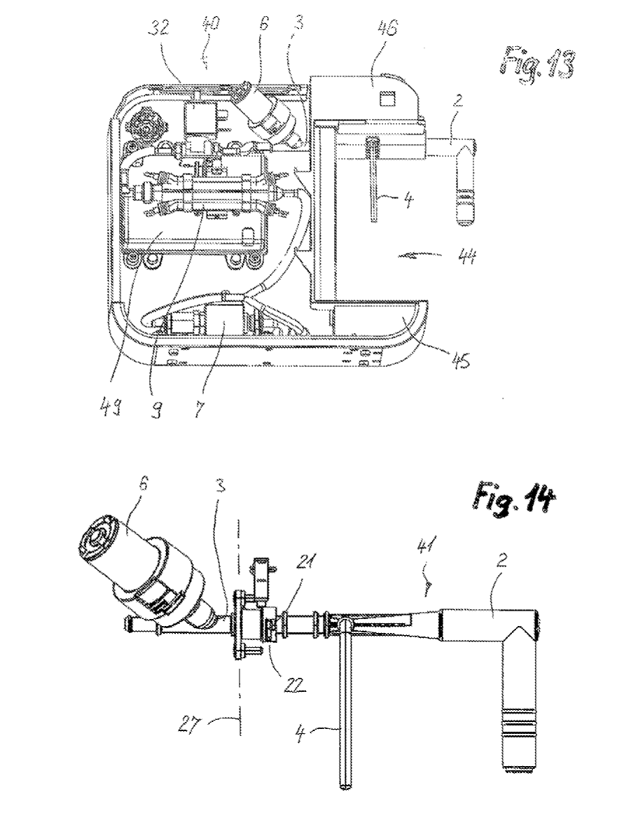

FIG. 14 is an illustration of a detail from FIG. 13 with the nozzle component attached,

FIG. 15 shows the nozzle from FIG. 14 on its own,

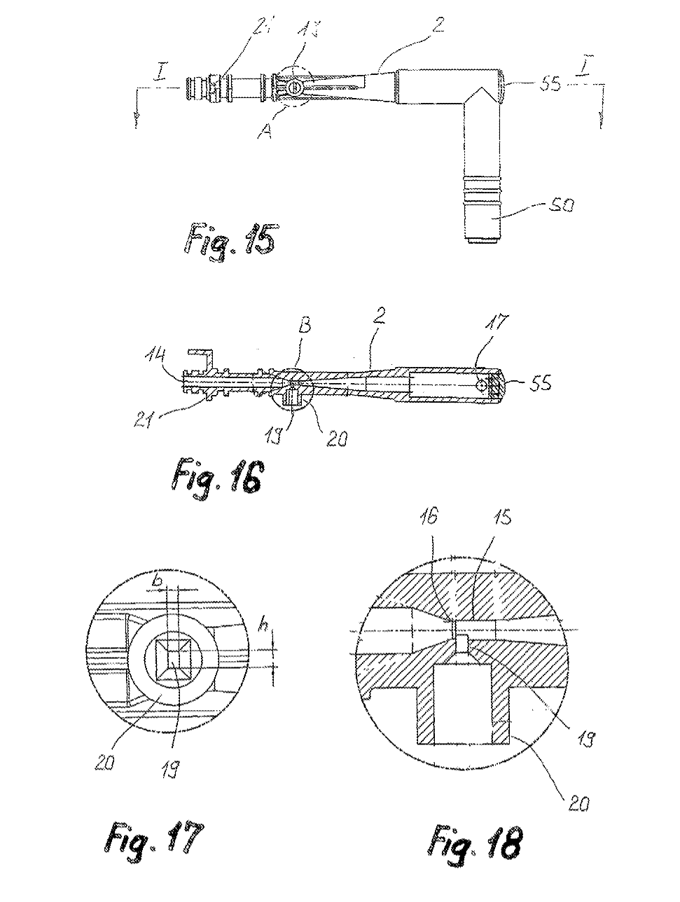

FIG. 16 shows a cross section through the plane I-I of the nozzle according to FIG. 15,

FIG. 17 shows the detail A of the nozzle according to FIG. 15,

FIG. 18 shows the detail B of the nozzle according to FIG. 16,

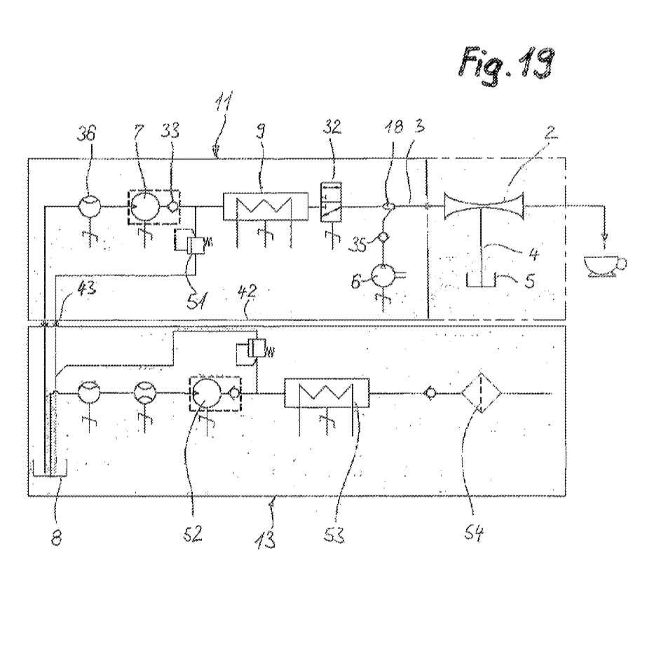

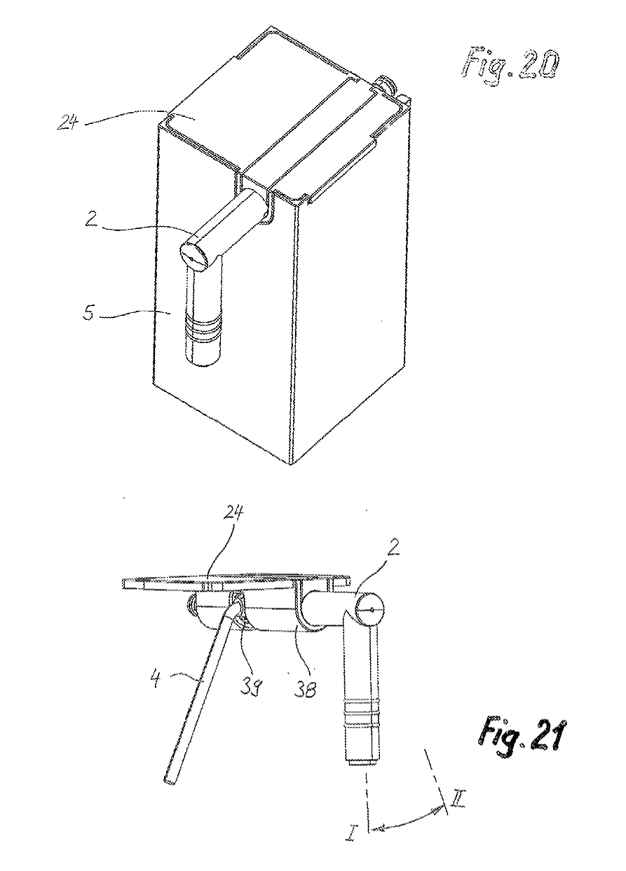

FIG. 19 is a schematic illustration of an entire coffee machine with the appliance component docked,

FIG. 20 is a perspective illustration of a milk container with a cover part and a nozzle in the storage position, and

FIG. 21 is a perspective illustration of the cover part on the milk container according to FIG. 17.

FIG. 1 shows an overall view of an arrangement, which is denoted 1, having a coffee machine 13 for brewing coffee K and a device 24 for producing milk froth S which is docked to said coffee machine. The coffee machine can be a conventional fully automatic coffee machine containing coffee beans or, by way of example, also a so-called capsule machine. The basic design of such coffee machines is known and familiar to a person skilled in the art, and therefore a more detailed description of the coffee machine can be dispensed with. The coffee machine 13 is equipped with means for generating steam and for supplying air for the purpose of emulsifying milk, steam and air for producing milk froth, said means not being shown here but being described in detail in the text which follows.

As shown in FIG. 1, the device 13 comprises a milk container 5 in which a nozzle 2 is integrated. The milk container is closed by a cover part 24. The nozzle 2 is pivotably fixed to the inside of the cover part 24. In FIG. 1, the nozzle is located in a pivoted-out position (discharge position) in which the milk froth S can be dispensed into a cup (not illustrated). 2′ indicates the nozzle in another discharge position.

The schematic illustration according to FIG. 2 shows the basic design and manner of operation of the milk frother device 11. In the device 11, steam, air and milk are mixed with one another and emulsified in a nozzle 2 (directions of flow are indicated by arrows). The milk froth which is generated in this way and is indicated by S finally enters a cup (not illustrated) or another receptacle. In order to produce steam, water W is drawn from a water container 8 with the aid of a water pump 7. The water is then routed through a steam heater 9. The steam is then routed to a nozzle 2 via a steam supply line 3. The nozzle 2 has a nozzle duct with a convergent-divergent duct cross section. The nozzle inlet opening is denoted 14, and the nozzle outlet opening is denoted 17. Milk M is drawn by suction from a milk container 5 into the nozzle 2 via a milk supply line 4 using the suction action which is generated by the accelerated flow in a constricted duct section of the nozzle 2.

In order to generate froth, air has to be admixed with the steam. To this end, air L, preferably in the form of ambient air, is supplied to the steam flow with the aid of an air pump 6 via an air supply line 30 under a pressure of 10 to 100 kPa. The air inlet opening 18 is located upstream of the nozzle inlet opening 14 at the front of the nozzle in relation to the direction of flow. A dashed line 27 indicates a housing wall of a coffee machine. The line 27 can—for specific embodiment variants (see FIGS. 3-7 below)—be considered to be a partition line which divides the device 11 into two parts. One part, that is to say firstly the components 7, 8, 9 for steam generation and secondly the component 6 for forced air supply, are associated with the coffee machine. The remainder of the device can be uncoupled from the coffee machine. The last-mentioned mobile part clearly includes—as shown in FIG. 2—the nozzle 2 and the milk container 5.

The partition line 27 clearly subdivides the device into an appliance component 40 and into a nozzle component 41, with easily detachable coupling means, which are described in more detail in the text which follows, being provided.

Different volumetric flows of air can be fed to the steam line depending on the desired beverage (for example for cappuccino or latte macchiato). The volumetric flow of air is controlled with the aid of a control means 12 with which the pumping capacity can be changed. However, it goes without saying that the device 11 can also be operated such that no air is fed. The device can therefore also be used to produce hot milk. A regulating valve (not illustrated) can be arranged in the air supply line 30. As an alternative, non-return valves or operated shut-off valves would be feasible instead of a regulating valve. The steam supply is preferably controlled with the aid of a control means 10 with which the pumping capacity of the water pump 7 can be varied. It goes without saying that the two control means 10 and 11 can be constituent parts of a common electronic data processing apparatus.

It is also feasible, in principle, for the milk to not be drawn by suction from a milk container which is associated with the device but rather to be drawn by suction directly from a cup and discharged back into the cup again. In the case of the device being used in this way, the run time of the process would have to be limited depending on the volume of the cup, in order to prevent the milk from being overheated.

Structural details of one possible refinement of the device 11 can be gathered from FIG. 3. The nozzle 2 is formed by an integral component. A plastic component of this kind can be produced in a simple manner in an injection-molding process. In addition to the nozzle inlet opening 14 and the nozzle outlet opening 17, the nozzle 2 has a milk supply line connection in the form of a milk intake fitting 20. The nozzle segments, which are in each case associated with the nozzle inlet opening 14 and the nozzle outlet opening 11, and the milk intake fitting 20 are each oriented at a right angle relative to one another. The milk supply line 4 which is indicated by dashed lines can be a flexible hose which can be fitted onto the milk intake fitting 20. A drinking straw which can be inserted into the milk intake fitting would also be feasible, said drinking straw not having to be cleaned since it is an expendable item. The use of milk supply lines which can be fitted in an exchangeable manner as disposable articles would also be highly advantageous in conventional milk froth nozzles.

The nozzle 2 can be inserted into the milk container. To this end, latching means 31 in the form of resilient latching arms are provided on the cover part 24 of the milk container, it being possible to accommodate the nozzle in a latching manner with the aid of said latching means. The cover part 24 can be composed of plastic and be a, preferably integral, injection-molded part. The milk container also contains a bowl- or tub-like base body 25 on which the cover part 24 (together with the nozzle 2) can be mounted. The milk container and nozzle form a mobile unit which can be uncoupled from the remainder of the device and can be docked to said remainder of the device again. A milk container which is filled with fresh milk can be stored in a refrigerator. Essentially only four components (including the milk supply line 4) are required for the mobile milk container/nozzle unit, it being possible for all of said components to be composed of plastic. The use of a few simple components in this way has a favorable effect on handling and costs.

FIG. 3 further shows that the air inlet is located outside the nozzle 2. The air inlet is created by an air inlet fitting 28 by means of which the air supply line 30 which is indicated by dashed lines can be connected to the steam supply line 3. The air L is therefore added to the steam stream D via an air inlet opening. The air pump (not illustrated here) is connected to the line 30. As described above, the steam D is produced with the aid of a steam generator (likewise not illustrated here). A pipe piece 23 which forms part of the steam supply line 3 is located within the housing 27 in the region of the interface to the machine. Part 23 is designed as a T-shaped pipe piece and has the abovementioned air inlet fitting 28 and a steam inlet fitting 29 by means of which in each case the lines, which are indicated by dashed lines, for the air L and the steam D can be connected. The air supply line 30 can be designed as a plastic hose. The hose which is denoted 3′ can be a temperature-resistant hose, for example a silicone-reinforced hose or else be composed of Teflon®.

In order to dock the mobile unit containing the milk container and the nozzle 2, the nozzle 2 has to be connected to the output of the steam supply line 3. The releasable connection can—as shown in FIG. 3 by way of example—be established by a bayonet fitting. To this end, appropriate connecting means 21 are arranged on the nozzle input side. A cutout 22, which complements the connecting means 21, for the bayonet fitting is provided on the housing wall 27. However, other detachable fixing means are also feasible.

As then shown in FIG. 3, the milk container is of approximately cuboidal design, with any desired other shapes being feasible. Both the cover part 24 and the base body 25 have a substantially approximately rectangular basic outline. A recess 26 for accommodating the nozzle 2 in a starting position is located on one side wall of the base body 25. An approximately U-shaped cutout into which the milk intake fitting 20 can be inserted can be seen on the cover-side end of said side wall.

In FIG. 4, the mobile unit comprising the milk container 5 and the nozzle is docked to the coffee machine. As shown in FIG. 4, the assembled milk container 5 forms a compact unit with the base body 25 and the cover part 24.

As shown in FIGS. 5 and 6, the nozzle can be pivoted between a starting position and a dispensing position. In FIG. 5, the nozzle 2 is located in a starting position in which the nozzle segment which is associated with the nozzle outlet opening 17 and has the corresponding duct section extends along the container wall of the base body 25 of the milk container. The nozzle 2 is pivoted-out in FIG. 6. In this position, milk froth (or hot milk) can be dispensed directly into a cup (not illustrated). The user has the option of matching the pivot angle to the size of the cup. However, pivoting also causes the above-described bayonet fitting to be moved to a closed position at the same time. The arrangement preferably has switching means (not illustrated) which are electrically or electronically connected to the control means for the water pump and the air pump. The switching means serve for presence monitoring and indicate whether the mobile unit is correctly attached. This can prevent the unintentional escape of steam, as a result of which reliable operation of the arrangement is ensured.

FIGS. 5 and 6 further show that the milk intake fitting 20 surrounds a milk supply duct 19 which is connected to the nozzle duct 15 in the region, for example, of the narrowest point.

The sectional illustration according to FIG. 7 shows, in particular, the design of the nozzle duct 15. The nozzle duct 15 first has an approximately cylindrical section which starts from the nozzle inlet opening 14 and which is adjoined by a tapering, approximately conical section. The duct section denoted 16, which creates the narrowest point of the nozzle duct, adjoins the tapering section. The milk supply duct 19 for drawing milk by suction issues into the end of the duct section 16. The steam/air mixture and the milk are mixed in this issuing region of the duct section 16. It goes without saying that other configurations would be feasible. For example, the mixing region could also be designed as a rectangular space which is wider than the smallest diameter of the ducts leading into it. An expanding, approximately conical duct section then adjoins the nozzle duct which is constricted in this way. Finally, the nozzle duct has an approximately cylindrical duct section in the region of the nozzle outlet opening 17. The duct section 16 has, for example, a diameter of between 0.5 and 2.5 mm, preferably of approximately 1.5 mm. The cross section of the milk supply duct 19 before being combined with the duct section 16 is between 0.5 mm² and 2.5 mm², preferably approximately 1.25 mm². The smallest diameter of the nozzle duct 15 following the narrowest point is between 0.6 mm and 2.7 mm, preferably approximately 1.7 mm. This diameter is clearly slightly greater than the smallest diameter of the duct section 16.

FIGS. 8 and 9 show an air connection for the milk frother device which is modified compared to the exemplary embodiment according to FIG. 3. FIG. 8 shows a longitudinal section through a pipe piece 23 which is part of the steam line 3. In contrast to the exemplary embodiment according to FIG. 3, the air inlet fitting is not oriented at a right angle to the steam line but the air is added to the steam stream D via an inclined air inlet fitting 28. In FIG. 8, a corresponding angle of inclination is indicated by α, which is, by way of example, approximately 45° in this case. However, it goes without saying that other angles of inclination would also be feasible (for example 30°<α<60°). A diaphragm valve 35 which is inserted into the air inlet fitting 28 is also shown. The air pump 6 directly adjoins said valve 35. An actual air supply line in the form of a separate hose piece (cf. FIG. 3) is not provided in the variant according to FIG. 8. FIG. 8 then shows that the air supply duct which creates the air inlet opening 18 has a considerably smaller duct cross section than the steam duct cross section in the mouth region into the steam stream. The diameter of the air supply duct in the mouth region into the steam stream can be between 0.2 and 2 mm (for example approximately 1 mm) and therefore serve as a diaphragm, while the diameter of the steam duct of the pipe piece 23 is, for example, 4 mm. However, this diaphragm can also be installed upstream of the diaphragm valve. In this case, the mouth region is equipped with a normal diameter of, for example, 3 mm.

FIG. 10 illustrates a flow diagram, which is more detailed than the exemplary embodiment according to FIG. 2, for a milk frother device 11 in a slightly modified form. FIG. 10 shows, for example, that the device 11 has a flow meter 36 which is operatively connected to the water pump 7 for control and regulation purposes. 33 denotes a non-return valve. Reference symbol 32 represents a 3/2-way valve. A valve 34 is connected to an output of the valve, it being possible for steam to be let out—instead of into the steam line 3—via said valve in the event of an overpressure. Excess residual water can be captured by a container 37. In order to protect the air pump, the non-return valve provided is a diaphragm valve 35.

FIGS. 11 to 13 illustrate a modified exemplary embodiment of a device according to the invention which can likewise be docked to a coffee machine. With the exception of the water tank, the device contains all the components which are required to generate milk froth independently of the coffee machine. In this case, the appliance component 40 is in the form of a cuboidal plate with rounded corners, with the outer shape obviously being matched to the coffee machine (not illustrated here). The milk container 5 is situated in an accommodation recess 44, which is formed by a bottom part 45 and a top part 46, which engage over the milk container 5 in the manner of tongs. However, the bottom part and the top part are constituent parts of a housing 47. The nozzle 2 projects out of a U-shaped clearance in the milk container 5.

It is clear from FIG. 12 that one side wall of the housing is in the form of a connection wall 42 which has connections 43 which communicate with corresponding connections on the coffee machine. A peripheral border 48 serves for exact positioning on the coffee machine.

Both said one side wall and the milk container are removed in the illustration according to FIG. 13. The nozzle 2 with the milk supply line 4 is actually not mounted on the top part 46 but rather on the cover part of the milk container (see FIG. 17). However, it would also be feasible for the nozzle 2 or the entire nozzle component to be detachably mounted on the top part 46 too, so that the appliance can also be operated without a milk container. For example, a commercially available milk carton could be inserted directly into the accommodation recess 44, it being possible to insert the milk supply line 4 through a small opening in the carton.

The air pump 6 which has already been described above is visible in the appliance, said air pump feeding air into the steam supply line 3 within the appliance. The water pump 7 is arranged on the floor of the appliance. Said water pump is supplied with water from the water tank of the coffee machine. The water passes from the water pump to the steam heater 9 which feeds steam to the connection nozzle 2 via the 3/2-way valve 32. The control box 49 is also visible behind the steam heater 9, the electrical and electronic components for controlling the system being accommodated in said control box.

FIG. 14 illustrates the nozzle component 41 with the nozzle 2 and the milk supply line 4 as an illustration of a detail. Said nozzle component is attached to the steam supply line 3 by means of a bayonet fitting 21, 22. In this case, the line 27 again indicates the housing wall from which the steam supply line 3 emerges.

The uncoupled nozzle 2 is illustrated in FIG. 15, with the flexible part of the milk supply line 4 (the riser pipe) also having been removed. In contrast to the exemplary embodiment according to FIG. 3, the nozzle duct runs between the nozzle inlet opening and the nozzle outlet opening in a straight line, and not at an angle of 90°, in this case. In spite of this, the milk supply line or the corresponding duct 19 which carries milk opens into the nozzle at the narrowest point of the nozzle duct. The ready milk froth is deflected for the first time at the end of a discharge pipe 50. For manufacturing-related reasons, the opening in the region of the deflection is closed by a cover 55 which is pressed in.

The entire duct configuration of the nozzle 2 in the straight region is clearly visible in the cross section according to FIG. 16, with reference also being made here to the details according to FIGS. 17 and 18. Starting from the nozzle inlet opening 14, the duct cross section is initially constricted conically as far as the narrowest point 16 to a diameter of, for example, 1.5 mm. This is directly followed by a hollow-cylindrical nozzle duct 15 which has a slightly larger diameter, specifically of, for example, 17 mm. Said nozzle duct 15 widens again only after a specific distance as far as the region of the deflection. The milk intake fitting 20 surrounds the milk supply duct which issues into the nozzle duct 15 directly following or partially still in the region of the narrowest point 16 in this case. However, the milk supply duct does not have a circular cross section, but rather a rectangular cross section with the width b and with the height h, as shown, in particular, in FIG. 17. By way of example, the width can be 1 mm and the height can be 1.25 mm, this resulting in a cross section of 1.25 mm².

FIG. 19 is a schematic illustration of a device 11 according to the invention in its entirety, said device being docked to a coffee machine 13. In this case, the components of the device 11 are almost identical to those according to FIG. 10. However, the device does not have its own water tank 8. Said water tank is contained in the coffee machine 13 and the corresponding lines are connected by means of the connections 43. In this case, excess water or excess steam is returned to the water container 8 of the coffee machine by means of an overpressure valve 51. The known elements of the coffee machine are not discussed in any detail here. However, said coffee machine has its own water pump 52 and a flow heater 53 for generating hot water. The coffee is brewed in a brewing chamber 54 and discharged separately from the milk froth.

In terms of the process, the following functions are possible with the system which is schematically illustrated in FIG. 16:

In order to produce milk froth, the steam generator 9 is first heated to a starting temperature at full heating power. If the system is cold or if the system was previously rinsed or descaled, the steam generator is heated to a higher defined starting temperature until the residual water is expelled by means of the overpressure valve 51. After this, or at the same time, water is additionally pumped in order to provide a defined steam cushion. During this preparation process, the valve 34 can be slightly opened for a brief period in order to ensure the correct pressure in the system.

When the system is still hot, the 3/2-way valve 32 is opened immediately when the desired temperature is reached, and the water pump 7 begins to feed water to the steam generator 9. The quantity of water can be regulated in the process. The temperature of the steam generator is kept constant throughout the entire process. As soon as hot steam flows through the nozzle 2, the suction action begins and milk is drawn by suction via the milk supply line 4. If the aim is to generate milk froth, air is simultaneously supplied to the air inlet opening 18 with the aid of the air pump 6 in a regulated manner. At the end of the process and after the pump is switched off, the 3/2-way valve closes and the supply of milk is interrupted. Ventilating the steam supply line 3 prevents milk froth or milk being sucked back into the steam heater. This can be achieved firstly by the valve 32 being a 3/2-way valve which ventilates the steam supply line 3 in the neutral position. However, if the valve 32 is a 2/2-way valve, it is also feasible to maintain operation of the air pump 6 or else to install a so-called vacuum relief valve in the steam supply line 3 and to prevent milk being sucked back in this way.

The system can also be flushed and cleaned with cold water, it being possible for this process to be enforced by the control system at specific intervals. During the rinsing process, the rinsing water flows out of the nozzle 2, without milk being drawn by suction from the container 5 or rinsing water returning to the milk container.

Like the coffee machine 13, the device 11 for generating milk froth also has to be descaled at specific intervals. In this case, the descaling operation is performed similarly to the rinsing operation, with the safety valve being slightly opened by the pump so that descaling agent can also flow through the safety valve and through the return line.

FIG. 20 shows the milk container according to figures and 12 in a state detached from the appliance component 40. The milk container, which is approximately cuboidal here, is closed by an accurately fitting cover part 24 which can be, for example, snapped onto the milk container.

FIG. 21 shows that the nozzle 2 is rotatably mounted in a bearing part 38 beneath the cover part 24. In this case, the milk supply line 4 projects out of a slot 39, so that it can rotate together with the nozzle 2 without impediment. The nozzle 2 can be pivoted between position I and position II, with the nozzle 2 being attached to the steam supply line in a pressure-tight manner by the pivoting movement. The position in which locking or unlocking are performed is not important here.

1-25. (canceled)

26. A device for producing milk froth
having a steam generator by means of which steam can be fed to a steam supply line,
having a nozzle which is constricted so as to achieve a suction action and has a nozzle inlet opening,
having a milk supply line which is connected to the nozzle in such a way that milk can be drawn into the nozzle from a milk container under suction action,
and also having an air pump for admixing air to the steam supply line at an air inlet opening which is located upstream of the nozzle inlet opening in relation to the direction of flow,
wherein the device is divided into two parts, specifically into a stationary appliance component containing the steam generator and the air pump, and into a mobile nozzle component containing the nozzle and the milk supply line, with the air inlet opening being situated within the appliance component, and the nozzle component being detachably connected to the steam supply line which leaves the appliance component.

27. The device as claimed in claim 26, the nozzle containing
the nozzle inlet opening,
a nozzle outlet opening, and
a milk supply line connection for connection of the milk supply line.

28. The device as claimed in claim 26, wherein the nozzle has a milk supply duct which opens into a nozzle duct of the nozzle in the region of the narrowest point in the constricted duct section.

29. The device as claimed in claim 26, wherein the nozzle has a nozzle duct with a deflection.

30. The device as claimed in claim 26, wherein the nozzle can be connected to the steam supply line by means of a bayonet fitting.

31. The device as claimed in claim 26, wherein a milk container is associated with the mobile nozzle component, and wherein the nozzle is fixed in a cover part of the milk container.

32. The device as claimed in claim 26, wherein the appliance component has control means by means of which the air pump for prespecifying the mixing ratio of the steam/air mixture in the steam supply line can be controlled.

33. The device as claimed in claim 26, wherein a diaphragm is arranged between the air pump and the steam supply line.

34. The device as claimed in claim 26, wherein the appliance component has a water container, a water pump which is connected to said water container and with which water can be supplied to the steam generator, and also control means for varying the pump output of the water pump.

35. The device as claimed in claim 26, wherein the appliance component has a housing having a docking point for accommodating the milk container, and wherein the appliance component can be docked to a coffee machine, with at least water and electricity being supplied by means of the coffee machine.

36. The device as claimed in claim 26, wherein the steam generator can be controlled in such a way that residual water and/or steam, which remains in said steam generator depending on preceding or subsequent process steps, can be expelled by heating the steam generator.

37. The device as claimed in claim 26, wherein the steam supply line and the nozzle can be flushed with water in such a way that no milk is drawn by suction via the milk supply line and no water flows into the milk tank.

38. The device as claimed in claim 26, wherein the mobile nozzle component is rotatably or pivotably mounted on the appliance component, and wherein a milk container can be connected to the milk supply line independently of the appliance component and/or of the nozzle component.

39. The device as claimed in claim 30, wherein the nozzle is rotatably mounted in the cover part in such a way that the bayonet fitting is closed in a first rotation position and is open in a second rotation position.

40. The device as claimed in claim 26, wherein the connection of the nozzle component to the appliance component can be established with the aid of a sensor, it being possible to activate steam generation in the appliance component only when the nozzle component is connected.

41. The device as claimed in claim 26, wherein the air can be fed to the steam supply line at a pressure of between 0.2 and 2 bar.

42. The device as claimed in claim 26, wherein the nozzle has a diameter of between 0.5 mm and 2.5 mm in the region of its narrowest point and a diameter of between 0.6 mm and 2.7 mm in the region of the nozzle duct immediately adjoining said region of the narrowest point of the nozzle.

43. The device as claimed in claim 26, wherein the milk supply line has a duct cross section of between 0.5 mm² and 2.5 mm² upstream of the nozzle.

44. The device as claimed in claim 26, wherein the nozzle has an outflow diameter of between 2 and 15 mm.

45. The device as claimed in claim 26, wherein a 3/2-way shut-off valve is arranged between the steam generator and the nozzle, said 3/2-way shut-off valve ventilating the steam supply line in the downstream direction in the closed state.

46. The device as claimed in claim 26, wherein the milk supply line and the nozzle outlet opening of the nozzle, or a discharge pipe which is connected to said nozzle outlet opening, are arranged on the mobile nozzle component in such a way that milk can be drawn by suction from a milk container, and can be dispensed back into the same milk container again as hot milk or milk froth.

47. The device as claimed in claim 26, wherein the steam generator can be controlled in such a way that, during a heating process, a defined quantity of water can be fed to the steam generator until a steam overpressure which can be limited by an overpressure valve or can be reduced by a controlled steam valve, builds up in the system before milk froth is delivered.

48. The device as claimed in claim 26, wherein the water pump can be operated by a working pressure at which a downstream overpressure valve can be slightly opened in order to allow the overpressure valve to be cleaned and descaled in a descaling operation.

49. The device as claimed in claim 26, wherein a 2/2-way shut-off valve is arranged between the steam generator and the nozzle, and wherein air can be fed to the steam supply line with the air pump in order to prevent a vacuum in the steam supply line in the downstream direction when the 2/2-way shut-off valve is closed.

50. A method of use of a device as claimed in claim 26 for drawing milk by suction from a milk container which is not associated with the device, and for dispensing hot milk or milk froth into the same milk container.
